(19) United States
(12) Patent Application Publication
(10) Pub. No.: US 2009/0171640 A1
(43) Pub. Date: Jul. 2, 2009

(54) POPULATION SEQUENCING USING SHORT READ TECHNOLOGIES

(75) Inventors: Nebojsa Jojic, Redmond, WA (US); Vladimir Jojic, Bellevue, WA (US); Tomer Hertz, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 11/966,446

(22) Filed: Dec. 28, 2007

(51) Int. Cl. G06G 7/48

(52) U.S. Cl. 703/11

(57) ABSTRACT

The claimed subject matter provides systems and/or methods that facilitate generating population sequences of strain variants included in a sample. Sequencing can be based on high throughput of short reads. Further, site variants exhibited in the short reads can be linked to reconstruct multiple full strains of a targeted gene, including low concentration variants in the sample. Cues in the short read data can be utilized to perform multi-strain assembly. For example, the cues can include different strain concentrations that lead to more frequently seen strains being responsible for more frequent reads and quilting of overlapping reads to infer mutation linkage over long stretches of DNA.

### BACKGROUND

The biochemical processes used to build and maintain living organisms are controlled by chains of nucleic acids, such as deoxyribonucleic acid (DNA) and ribonucleic acid (RNA). Each nucleic acid is made up of a sequence of nucleotides consisting of a sugar (e.g., deoxyribose, ribose) and a nitrogen base having a triphosphate group (abbreviated as dNTP, d=deoxyribose, N=nitrogen base, TP=triphosphate). The bases that make up DNA are adenine (A), cytosine (C), guanine (G) and thymine (T). RNA molecules have the base uracil (U) instead of thymine.

A molecule of DNA can exist as two nucleic acid strands linked together by hydrogen bonds between the bases of each strand to form a double-helical structure (double-stranded DNA (dsDNA)). The bases will only bind specifically to each other (adenine to guanine and cytosine to thymine) such that the strands of a dsDNA molecule are complementary. DNA also can exist as a single-stranded molecule (ssDNA), such as the DNA in the parvovirus. A molecule of RNA can be single stranded (ssRNA), or in some organisms (e.g., rotavirus) it is double-stranded (dsRNA), with cytosine binding to uracil.

Determining the sequence of a nucleic acid strand is useful for a variety of research and commercial applications (e.g., basic science research, applied research, forensics, paternity testing, . . . ). Thus, nucleic acid sequencing tools are some of the most important tools in biotechnology. Further, despite many drawbacks, traditional sequencing technologies have proven to be invaluable in modern medical research, even when the targeted genomes are highly variable. While it is often known in such cases that multiple slightly different sequences are present in an analyzed sample in concentrations that vary dramatically, the traditional techniques typically allow only the most dominant strain to be extracted from a single chromatogram. These limitations have made some research directions rather difficult to pursue. For example, the analysis of HIV evolution (including the emergence of drug resistance) in a single patient is expected to benefit from a comprehensive catalog of the patient's HIV population.

Sequencing multiple different strains from a mixed sample in order to study sequence variation is often of great importance. For example, it is well known that even single mutations can sometimes lead to various diseases. On the other hand, mutations in pathogen sequences such as the highly variable HIV can lead to drug resistance. At any given time, an HIV positive individual typically carries a large mixture of strains, each with a different relative frequency. Some strains can be over a hundred times less abundant than the dominant strains, and any one of them can become dominant if others are under greater drug pressure. The emergence of drug resistant HIV strains has lead to assembling a large list of associated single mutations. However, new studies are showing that there are important linkage effects among some of these mutations and that the linkage can be missed by current sequencing techniques.

When processing mixed samples by traditional methods, only a single strain typically can be sequenced in each sequencing attempt. Multiple DNA purifications can be costly and can usually provide accurate reconstruction only of dominant strain(s). Picking the less abundant strains from the mixture can be a harder problem. Recent computational approaches which infer a mixture of strains directly from the ambiguous raw chromatograms of mixed samples oftentimes can deconvolve strains reliably only when their relative concentrations are higher than 20%, as the rarer variants typically are masked. Note that unlike the problem of metagenome sequencing, where multiple species are simultaneously sequenced, the goal of multiple strain sequencing is to recover a mixture of different full sequence variants of the same species, which is complicated by the high similarity among them.

Recently, a number of alternative sequencing technologies have enabled high-throughput genome sequencing. For example, 454 sequencing is based on an adaptation of the pyrosequencing procedure. Several studies have demonstrated its use for sequencing small microbial genomes, and even some larger scale genomes. One of the major advantages of pyrosequencing is that it has been shown to capture low frequency mutations. However, these technologies can be limited. For instance, current sequencers can read sequences of about 200 base pairs (and some even less). Moreover, sequencing errors, especially in homopolymeric regions, are high, making it potentially difficult to reconstruct multiple full sequences and estimate their frequencies.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The claimed subject matter relates to systems and/or methods that facilitate generating population sequences of strain variants included in a sample. Sequencing can be based on high throughput of short reads. Further, site variants exhibited in the short reads can be linked to reconstruct multiple full strains of a targeted gene, including low concentration variants in the sample. Cues in the short read data can be utilized to perform multi-strain assembly. For example, the cues can include different strain concentrations that lead to more frequently seen strains being responsible for more frequent reads and quilting of overlapping reads to infer mutation linkage over long stretches of DNA.

In accordance with various aspects of the claimed subject matter, population sequences can be generated based on short reads. For instance, a read generation component can obtain short reads from a sample that includes a plurality of strain variants. The strain variants can be from one species and/or from multiple species. Moreover, a reconstruction component can combine the short reads to generate sequenced genomes associated with the plurality of strain variants in the sample. The reconstruction component can also determine relative concentrations of the strain variants in the sample. Accordingly, in contrast to conventional sequencing techniques that typically are unable to sequence less frequent strains in a sample (e.g., techniques that can yield a sequence for a dominant strain), the claimed subject matter enables sequencing multiple strains from the sample.

The following description and the annexed drawings set forth in detail certain illustrative aspects of the claimed subject matter. These aspects are indicative, however, of but a few of the various ways in which the principles of such matter may be employed and the claimed subject matter is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of an example system that enables generating population sequences based on high throughput of short reads.

FIG. 2 illustrates an example depiction of population sequencing using short reads.

FIG. 3 illustrates a block diagram of an example system that sequences strains based upon a model of a sample.

FIG. 4 illustrates a block diagram of an example system that reconstructs strains from short reads of a sample.

FIG. 5 illustrates a block diagram of an example system that sequences multiple different strains from a mixed sample.

FIG. 6 illustrates a block diagram of an example system that yields inferences in connection with sequencing multiple strain variants from a mixed sample.

FIG. 7 illustrates an example methodology that facilitates sequencing multiple variants included in a mixed sample.

FIG. 8 illustrates an example methodology that facilitates reconstructing strains based upon probabilistic inferences.

FIG. 9 illustrates an example networking environment, wherein the novel aspects of the claimed subject matter can be employed.

FIG. 10 illustrates an example operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, . . . ), optical disks (e.g., compact disk (CD), digital versatile disk (DVD), . . . ), smart cards, and flash memory devices (e.g., card, stick, key drive, . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Moreover, the term “sequence” generally refers to a molecular sequence, for instance, a nucleotide sequence (e.g., DNA, RNA). The term “sequencing” generally refers to a process for identifying the components of a molecular sequence. For example, DNA can be amplified and sequenced using PCR, the Sanger chain termination method and an automated DNA sequencer. RNA can be sequenced by first converting the RNA to a complementary DNA strand (cDNA) using the reverse transcriptase polymerase chain reaction (RT-PCR) followed by sequencing the cDNA. The RNA sequence is complementary to the sequenced cDNA with the exception that the RNA strands have uracil at those cDNA positions having a thymine. Since RNA viruses, such as HIV, use reverse transcriptase (RT) in vivo to reverse transcribe the viral RNA to viral cDNA (which is then incorporated into the host's genome), those portions of the host's genome corresponding to the viral DNA can be sequenced directly.

The term “sample” generally refers to one or more molecular entities to be analyzed. Samples can be singular sequences or polymorphic mixtures of sequences. Polymorphic samples can be, for example, DNA corresponding to strains of a highly-mutable virus or to variable and highly variable regions of a genome or any other sample of mixed sequences (e.g., DNA complementary to a mixed RNA sample). The samples can be naturally occurring or synthetic molecular entities.

Mixed samples can arise because DNA replication during cell division is imperfect and this can result in mutations being introduced into the genome. Mutations can be a single nucleotide change (point or site mutation) or insertions/deletions (indels) of subsequences. HIV is very prone to site mutations and indels, which make chromatography difficult because, as described above, the algorithm utilized by existing base callers is based on the assumption that the sequencer will produce clean data (e.g., one peak per sequence position). When a sample containing mixtures of DNA from different viral strains is analyzed, many positions have more than one peak (corresponding to differences in the sequences) and this can result in inaccurate base calls.

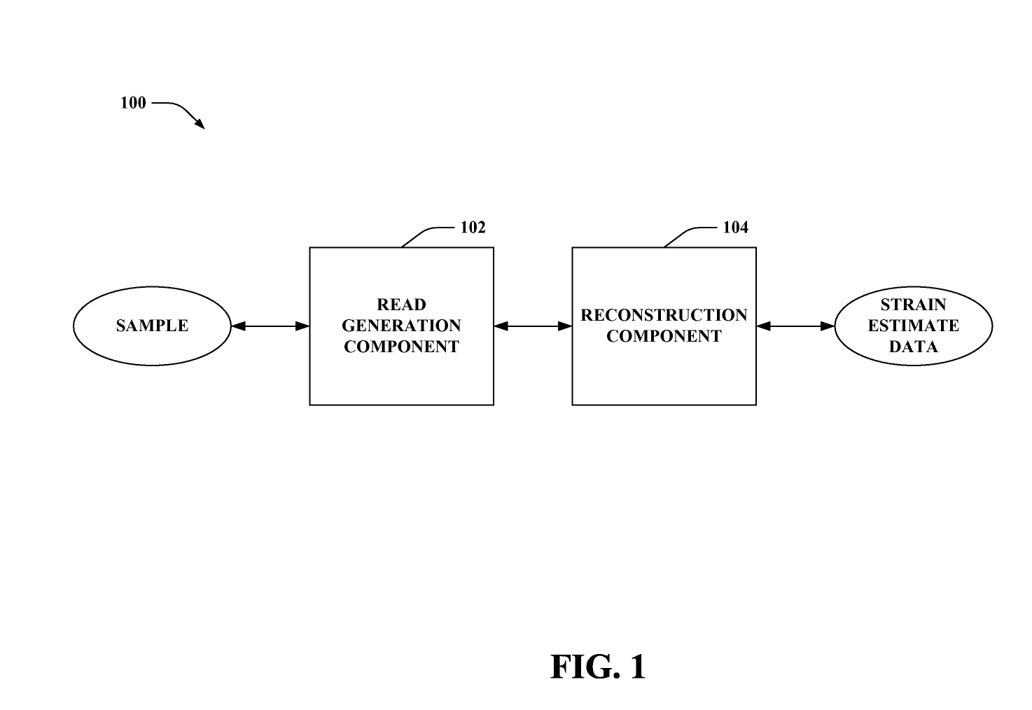

Now turning to the figures, FIG. 1 illustrates a system 100 that enables generating population sequences based on high throughput of short reads. The system 100 can be used to link site variants and reconstruct multiple full strains of a targeted gene, including those of low concentration in a sample. Further, the system 100 can leverage a generative model of the sequencing process and can utilize a tailored probabilistic inference and learning procedure to fit the model to the obtained reads. Thus, the system 100 can reconstruct full strains from mixed samples. For instance, the system 100 can employ a statistical model of short reads and an inference algorithm, which can be used to jointly reconstruct sequences from the reads and infer their frequencies.

The system 100 includes a read generation component 102 that can generate short reads (e.g., short sequenced patches of DNA segments) from a sample that can include various full strains (e.g., each full strain can be associated with a unique molecular sequence). The full strains in the sample can be related to each other; for instance, the sample can include variants from one species or multiple related species (e.g., differences exhibited in full strains included in the sample can be based upon mutation(s), insertion(s), deletion(s), . . . ). Further, the read generation component 102 can obtain the short reads from a mixture of samples. Accordingly, the read generation component 102 can accommodate multiplexing (e.g., deliberately mixing samples and thereafter separating sequences computationally to mitigate sequencing costs) and/or bulk sequencing (e.g., obtaining a sample of ocean water, for instance, to determine short reads from many species in the sample). Additionally or alternatively, the read generation component 102 can be an interface that obtains short reads from a disparate component (not shown). The system 100 can further include a reconstruction component 104 that can stitch the short reads together to generate strain estimate data, which can include a plurality of sequenced genomes for full strains included in the sample, relative concentrations of the strains in the sample, and so forth.

The read generation component 102 can employ high throughput, short read technology to create a large number of short reads. Moreover, the read generation component 102 can sample reads from different strains (e.g., differing variants in the sample) depending on the strain concentrations in the sample. Further, the sample can include other hidden variables, such as random insertions and deletions when the reads include homopolymers. The reconstruction component 104 can thereafter utilize optimization criterion in the form of the likelihood of the observed reads. Further, the reconstruction component 104 can perform multi-strain assembly based upon likelihood optimization that leverages various cues in the short read data yielded by the read generation component 102. For example, the cues can be different strain concentrations which lead to more frequently seen strains being responsible for more frequent reads, quilting of overlapping reads to infer mutation linkage over long stretches of DNA, and the like.

According to an illustration, the read generation component 102 can yield any number of short reads. The short reads can have different lengths, differing starting positions, and can overlap heavily so that each site in the sequence can be included in a plurality of the short reads, which can be the depth of reading (e.g., number of reads that capture a certain site in a genome). Each short read can have substantially any length (e.g., lengths can be around 50 nucleotides, 100 nucleotides, 200 nucleotides, 500 nucleotides, . . . ) and/or can be associated with any variant included in the sample. Further, the short reads provided by the read generation component 102 can overlap with each other.

Pursuant to an illustration, the sample can include a virus species with a sequence length of 200 base pairs. Following this illustration, 10 of the 200 positions in the sequence can vary, for instance. Assuming that each of the 10 positions can be one of two different possible bases, then 1000 different strains of the virus species can be possible (e.g., 2¹⁰ possible strains). Accordingly, it can be medically important to know which strains are present (and/or concentrations of the strains) since some strains can be drug resistant, some strains may have evolved due to immune system and/or drug pressure, and the like. For example, a minor strain can be 20 times less frequent than a dominant strain at a given time; however, it can be advantageous to know about the presence of the minor strain since a cocktail of drugs can be provided to a patient to address both the dominant and minor strains. The reconstruction component 104 can extract the strains and the frequencies of each of the strains. For instance, the reconstruction component 104 can recognize linkage of mutations (site variants). Thus, in accord with the above illustration, the reconstruction component 104 can determine which of the 1000 possible strains are included in the sample. The short reads can be obtained by the read generation component 102 from differing regions of the 200 nucleotides. For instance, a first short read can be from position 1 to position 30, a second short read can be from position 5 to position 45, a third short read can be from position 17 to position 37, and so forth. Moreover, certain positions can be highly variable such as position 4, position 15, and position 35 in this example. Accordingly, the reconstruction component 104 can utilize the overlapping nature of the short reads to determine a site variant at position 4 that connects to a site variant at position 35 even though position 4 and position 35 may not be included in a common short read, for instance. Additionally or alternatively, the reconstruction component 104 can consider frequency of a variant at each position when linking variants (e.g., high frequency variants can be connected and low frequency variants can be connected); thus, at a particular position, 900 short reads can have a C and 100 short reads can have an A, while at a disparate position, 90% of the short reads can have an A and 10% can have a G. It is to be appreciated, however, that the claimed subject matter is not limited to the aforementioned illustration.

Conventional techniques typically can sequence one or possibly two dominant strains included in a sample while being unable to sequence less frequent strains. In contrast, the system 100 can effectuate population sequencing for multiple strains from a sample. The data yielded by the system 100 can be employed in connection with a number of applications such as, for example, alternative splicing, detecting multiple strains of a virus, sensing multiple species of different viruses in a broad sample, multiplexing completely different species, evaluating samples from different patients (e.g., to reduce costs), and so forth.

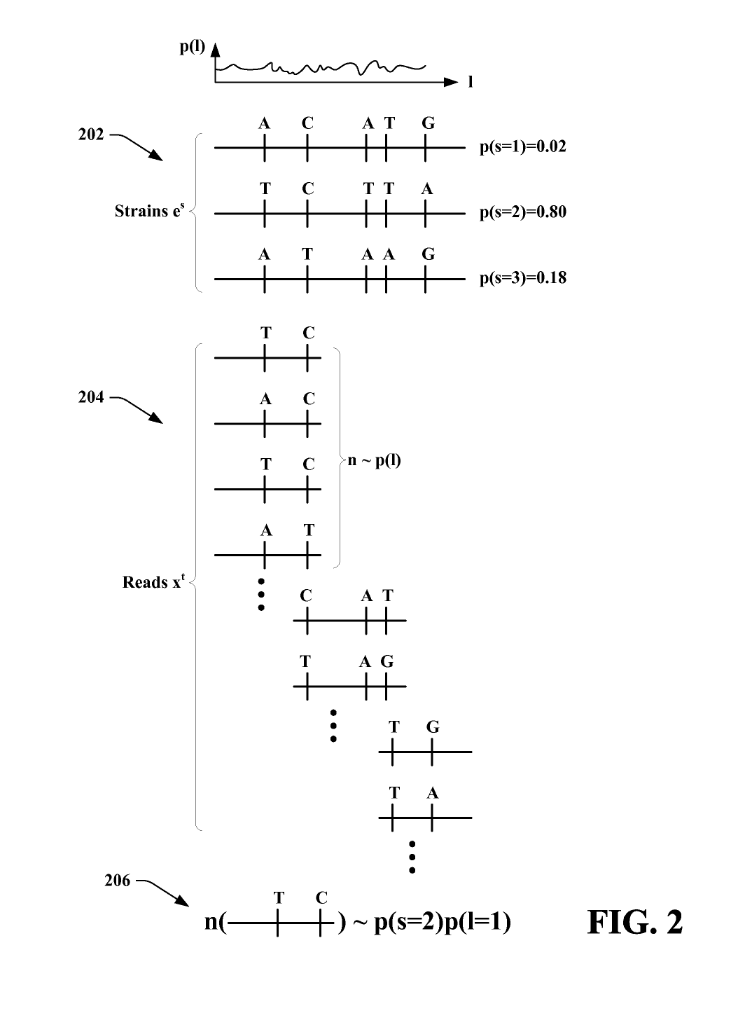

Turning to FIG. 2, illustrated is an example depiction of population sequencing using short reads. In this example, three strains 202 with five polymorphic sites are present in the sample. Each of the three strains 202 can have a respective concentration p(s) within the sample. Short reads 204 from various locations are taken (e.g., by the read generation component 102 of FIG. 1). As the coverage depth depends on sequence content, the coverage depth can be proportional to the distribution p(l) over the sequence location (the strains are assumed to differ little enough so that the depth of coverage of polymorphic variants of the same sequence patch are similar). The number of copies of a particular read (e.g., variant 206 that includes T and C, respectively, at the first two polymorphic sites) can depend both on the strain concentrations p(s) and the depth distribution p(l).

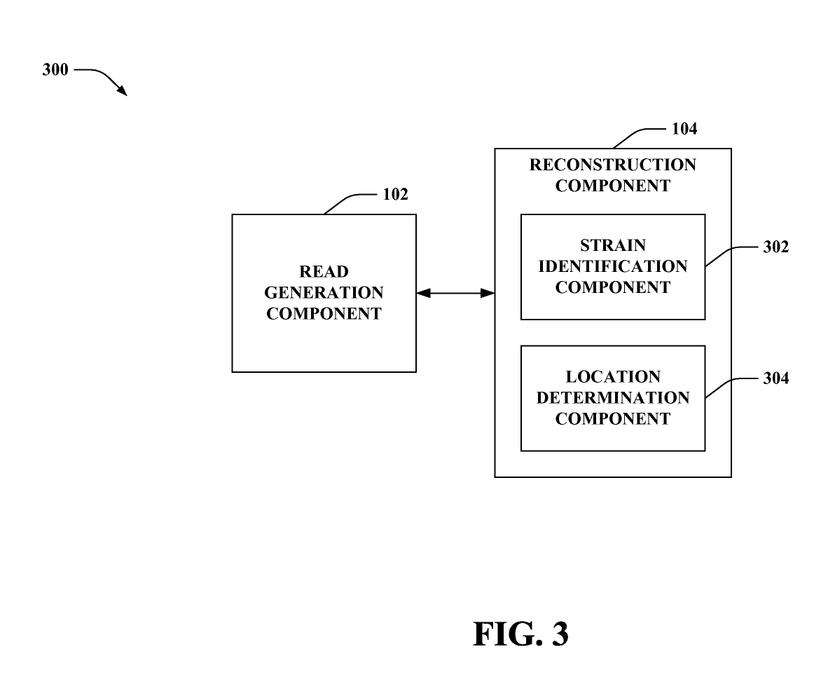

Now referring to FIG. 3, illustrated is an example system 300 that sequences strains based upon a model of a sample. The system 300 can include the read generation component 102 that can obtain short reads from various strains included in the sample and the reconstruction component 104 that can assemble the short reads to yield data related to sequences of various strains included in the sample. Further, the reconstruction component 104 can include a strain identification component 302 and a location determination component 304.

The read generation component 102 can provide a set of short reads to the reconstruction component 104. Each of the short reads in the set can be sampled from a particular strain at a particular location. The strain identification component 302 can evaluate each short read to determine an identity of a strain from which the particular short read is taken. Moreover, the location determination component 304 can analyze the short read to recognize a position associated with the short read within a sequence.

The sample can include S strains e^{s} indexed by s ε [1 . . . S] with unknown relative concentrations p(s). A single short read from a sequencer (e.g., the read generation component 102) is a patch x={xᵢ}ᵢ₌₁^{N}, with N≈100 and xᵢ denoting the i-th nucleotide, taken from one of these strains starting from a random location l. For instance, 454 sequencing can be employed by the read generation component 102. In 454 sequencing, a patch depth can be dependent on the patch content. Further, it can be assumed that different strains have highly related content in segments starting at the same location l, and thus, capture the expected relative concentrations of observed patches by a probability distribution p(l), shared across the strains. This distribution can also be unknown and can be estimated from the data. Further, the reconstruction component 104 can evaluate the obtained short reads. For instance, the strain identification component 302 can determine a sample strain s from the distribution p(s) from which each short read is derived. Moreover, the location determination component 304 can determine a sample location l from the distribution p(l) associated with each short read. Further, for example, the reconstruction component 104 can set xᵢ=eᵢ₊ₗ₋₁^{s}, for i ε0 [1 . . . N].

It can also be assumed that the strains e^{s} are defined as nucleotide sequences e^{s}={eᵢ^{s}}. However, since the reconstruction component 104 seeks to assemble the observed patches x^{t} into multiple strains, the definition of e can be softer in order to facilitate smoother inference of patch mapping in early phases of the assembly when the information necessary for this mapping is uncertain. In particular, an assumption can be utilized such that each site eᵢ^{s} is a distribution over the letters from the alphabet (in this case four nucleotides A, C, G, and T (or U)). Thus, the probability of the nucleotide xⱼ under the distribution at coordinates (s, i) of the strain description e can be denoted as eᵢ^{s}(xⱼ). This model can be a statistical model of patches included in larger sequences and can be referred to as an epitome. Thus, the reconstruction component 104 can yield a model of the patches x such that x can be sampled by the reconstruction component 104 by sampling for each i ε [1 . . . N] the nucleotide xᵢ from the distribution eᵢ₊ₗ₋₁^{s}(x).

While the epitome distributions can capture both uncertainty about reconstructed strains and point-wise sequencing errors, in order to model possible insertions and deletions in the patch, which can be important because of the assumed strain alignment (shared l), another variable can be utilized by reconstruction component 104. Namely, the reconstruction component 104 can evaluate a transformation, τ, that describes the finite set of possible minor insertions and/or deletions. The insertions and deletions can come from two sources: a) homopolymer issues in sequencing and b) insertions and deletions among strains. The first set of issues arises when a sequence of several nucleotides of the same kind (e.g., AAAA, . . . ) is included in the patch. For instance, the number of sequenced letters in the obtained patch can differ from the true number included in the sequence. As opposed to the indels among strains, which are usually multiples of three nucleotides to preserve translation into amino acids, as well as consistent across the reads, the homopolymer indels are not limited in this way. The transformation, τ, describes a mini alignment between the read and the epitome segment describing the appropriate strain s starting at a given location l. The transformation, τ, can be assumed to affect the epitome segment just before the patch is generated by sampling from it.

According to an example, the strain identification component 302 can identify a sample strain s from the distribution p(s) and the location determination component 304 can evaluate a sample location l from the distribution p(l). Further, the reconstruction component 104 can analyze a sample patch transformation, τ, from p(τ) and transform the epitome segment {eᵢ^{s}}ᵢ₌ₗ^{l+N+Δ}, with Δ allowing all types of indels that can be modeled. This transformation can provide a new set of distributions e_{τ(k)}^{s}, where the operator notation for τ denotes the mapping of locations. Additionally, the reconstruction component 104 can sample x from p(x|s,l,τ,e)=Πᵢe_{τ(i+l-1)}^{s}(xᵢ) by sampling for each i ε [1 . . . N] the nucleotide xᵢ from the distribution e_{τ(i+l-1)}^{s}(x).

Each read x^{t} yielded by the read generation component 102 can have a triplet of hidden variables s^{t}, l^{t}, τ^{t} describing its unknown mapping to the catalog of probabilistic strains (epitome). In addition to hidden variables, the model has a number of parameters, including relative concentrations of the strains p(s), the variable depth of coverage for different locations in the genome p(l), and the uncertainty over the nucleotide x present at any given site i in the strain s, as captured by the distribution eᵢ^{s}(x) in the epitome e describing the S strains. If the model is fit to the data well, the uncertainty in the epitome distributions eᵢ^{s} can contract to reflect the measurement noise (e.g., around 1%). But, if an iterative algorithm (e.g., EM) is used to jointly estimate the mapping of all reads x^{t} and the (uncertain) strains e^{s}, then the uncertainty in these distribution also can smooth out the learning process and avoid hard decisions that are known to lead to local minima. Thus, these distributions can be uncertain early in such learning procedures and contract as the mappings become more and more consistent. In the end, each of the distributions eᵢ^{s} can focus most of the mass on a single letter, and the epitome e can simply become a catalog of the top S strains present in the sampled population. If more than S strains are present, this can be reflected by polymorphism in some of the distributions eᵢ^{s}.

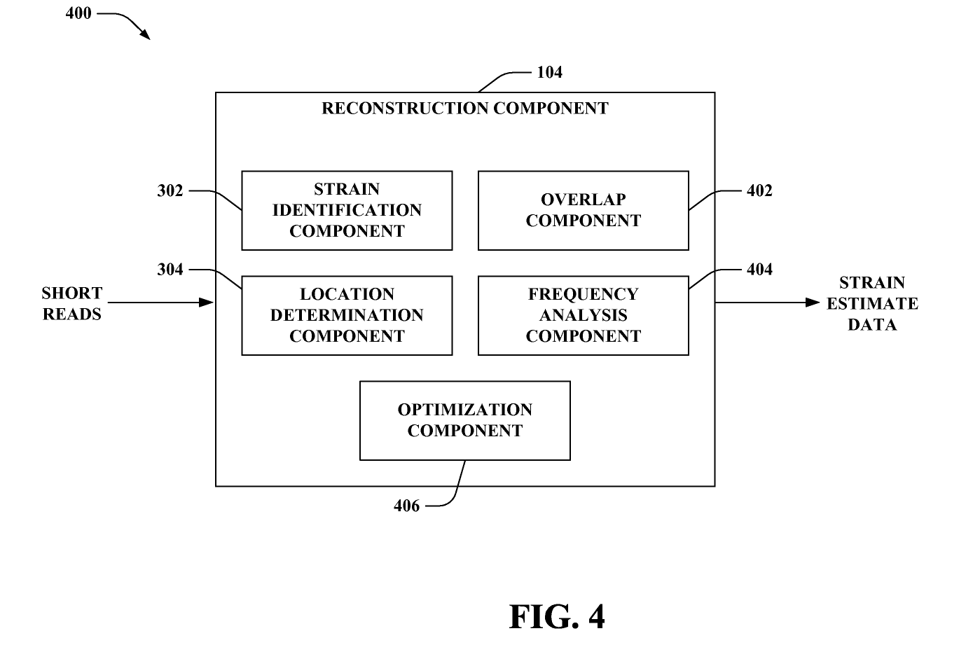

Turning to FIG. 4, illustrated is a system 400 that reconstructs strains from short reads of a sample. The system 400 includes the reconstruction component 104 that obtains short reads and can yield strain estimate data. The reconstruction component 104 can further include the strain identification component 302 and the location determination component 304 as described above. Further, the reconstruction component 104 can include an overlap component 402, a frequency analysis component 404, and an optimization component 406. The overlap component 402 can enable reconstruction to be effectuated based upon utilizing overlap of short reads. The overlap component 402 can link site variants from differing short reads based upon overlapping portions of the short reads; similarity of highly variable sites in the overlapping portions can indicate that a plurality of short reads are associated with a common strain. Further, the frequency analysis component 404 enables performing an analysis of frequencies of variants exhibited in the set of short reads. The frequency analysis component 404 can link site variants based upon respective frequencies exhibited in the set of short reads. Accordingly, the frequency analysis component 404 can link high frequency site variants with other high frequency site variants, low frequency site variants with other low frequency site variants, and so forth.

The reconstruction component 104 can reconstruct strains based upon probabilistic inference algorithm performed, coordinated, etc. by the optimization component 406, for example. According to an illustration, the algorithm can be effectuated as follows. The optimization component 406 can initialize distributions eᵢ^{s}, strain concentrations p(s) and coverage depth p(l). Further, the strain identification component 302 can find a best strain, s^{t}, for each short read and the location determination component 304 can find a best location in the strain, l^{t}, corresponding to each short read. The reconstruction component 104 (and/or an alignment component (not shown)) can determine a best mini alignment, τ^{t}, that considers indels for each short read. Thereafter, the optimization component 406 can map the identified s^{t}, l^{t}, and τ^{t} to a strain reconstruction, e. Moreover, model parameters can be re-estimated by employing the frequency analysis component 404 to count how many reads map to different locations l and different strains s. The frequency analysis component 404 can also count how many times each nucleotide ended up mapped to each location (s, i) in the strain reconstruction, e; this enables the distributions eᵢ^{s} to be updated by the optimization component 406 to reflect the relative counts. The optimization component 406 can continue to iterate until convergence.

This meta algorithm effectuated by the optimization component 406 can correspond to an expectation-maximization (EM) algorithm that optimizes the likelihood of obtaining the given set of reads x^{t} from the statistical generative model; however, it is to be appreciated that any optimization technique can be utilized in addition to or instead of the EM algorithm. Further, the log likelihood of observing a given set of patches (e.g., reads) can be:

$$L = {\sum }_{t} log p ( {x}^{t} ) = {\sum }_{t} log {\sum }_{{s}^{t} , {l}^{t} , {τ}^{t}} p ( {s}^{t} ) p ( {l}^{t} ) p ( {τ}^{t} ) p ( {x}^{t} \vert {s}^{t} , {l}^{t} , {τ}^{t} ) . \qquad ( 1 )$$

The likelihood, L, can be a function of model parameters e, p(s), p(l) and p(τ). Further, the optimization component 406 can maximize this likelihood with regards to e as well as p(s). Accordingly, the output (e.g., strain estimate data) can be a catalog of strains, or epitome e, present with the component concentrations p(s). The optimization component 406 can additionally or alternatively maximize the log likelihood with regards to other parameters such as, for example, an estimate of the varying coverage depth for different parts of the strains as well as distribution over typical indels. Utilization of these parameters can increase the accuracy of the estimates of strains and the corresponding frequencies.

To express the expectation-maximization (EM) algorithm, auxiliary distributions q(s^{t}, l^{t}) and q(τ^{t}|s^{t},l^{t}) can be used to describe the posterior distribution over the hidden variables for each read x^{t}. Additionally, Jensen's inequality can be employed to bound the log likelihood:

$$L ( e ) = {\sum }_{t} log {\sum }_{{s}^{t} , {l}^{t} , {τ}^{t}} q ( {s}^{t} , {l}^{t} ) q ( {τ}^{t} \vert {s}^{t} , {l}^{t} ) \frac{p ( {s}^{t} ) p ( {l}^{t} ) p ( {τ}^{t} ) p ( {x}^{t} \vert {s}^{t} , {l}^{t} , {τ}^{t} , e )}{q ( {s}^{t} , {l}^{t} ) q ( {τ}^{t} \vert {s}^{t} , {l}^{t} )} , \\ \geq {\sum }_{t} {\sum }_{{s}^{t} , {l}^{t} , {τ}^{t}} q ( {s}^{t} , {l}^{t} ) q ( {τ}^{t} \vert {s}^{t} , {l}^{t} ) log \frac{p ( {s}^{t} ) p ( {l}^{t} ) p ( {τ}^{t} ) p ( {x}^{t} \vert {s}^{t} , {l}^{t} , {τ}^{t} , e )}{q ( {s}^{t} , {l}^{t} ) q ( {τ}^{t} \vert {s}^{t} , {l}^{t} )} .$$

The bound can be tight when the q distribution captures the true posterior distribution p(s^{t}, l^{t}, τ^{t}|x^{t}); thus, q can be referred to as a posterior distribution. By optimizing the bound with respect to the q distribution parameters (under the constraint that the appropriate probabilities add up to one), E can be derived as:

q(τ^{t}|s^{t},l^{t})∝ p(τ^{t})p(x^{t}|s^{t},l^{t},τ^{t},e) (2)

q(s^{t},l^{t})∝ p(s^{t})p(l^{t})e^{Σ}^{_{τ}}^{q(τ}^{^{t}}^{|s}^{^{t}}^{,l}^{^{t}}^{)log p(τ}^{^{t}}^{)p(x}^{^{t}}^{|s}^{^{t}}^{,l}^{^{t}}^{,τ}^{^{t}}^{,e)} (3)

where both the computation of q(τ^{t}|s^{t},l^{t}) and the summation over τ in the second equation can be performed efficiently by dynamic programming. These operations can reduce to an HMM alignment of two sequences (e.g., one probabilistic sequence, {eᵢ^{s}}ᵢ₌ₗ^{l+N+Δ}, and one deterministic sequence, x^{t}), because they estimate optimal alignment (e.g., and/or the distribution over alignments, an expectation under it, . . . ), in the presence of indels. Further, an additional assumption can be that q(τ^{t}|s^{t},l^{t}) puts all probability mass on one, best, alignment.

The bound can simplify the estimation of model parameters under the assumption that the q distribution is fixed. For example, the estimate of the (relative) strain concentrations and the spatially varying (relative) depth coverage can be performed by:

$$p ( s ) = \frac{{\sum }_{t} {\sum }_{{l}^{t}} q ( {s}^{t} = s , {l}^{t} ) p ( {l}^{t} )}{{\sum }_{t} {\sum }_{{l}^{t}} {\sum }_{{s}^{t}} q ( {s}^{t} , {l}^{t} ) p ( {l}^{t} )} \\ p ( l ) = \frac{{\sum }_{t} {\sum }_{{s}^{t}} q ( {s}^{t} , {l}^{t} = l ) p ( {s}^{t} )}{{\sum }_{t} {\sum }_{{l}^{t}} {\sum }_{{s}^{t}} q ( {s}^{t} , {l}^{t} ) p ( {s}^{t} )} . \qquad ( 4 )$$

The estimate for the epitome probability distributions describing (with uncertainty) the strains present in the population can be:

$${e}_{i}^{s} ( x ) = \frac{{\sum }_{t} {\sum }_{{l}^{t} , τ , j \vert τ ( j + l - 1 ) = i} [ {x}_{j} = x ] q ( {s}^{t} = s , {l}^{t} ) q ( τ \vert {s}^{t} = s , {l}^{t} )}{{\sum }_{t} {\sum }_{{l}^{t} , τ , j \vert τ ( j + l - 1 = i )} q ( {s}^{t} = s , {l}^{t} ) q ( τ \vert {s}^{t} = s , {l}^{t} )} , \qquad ( 5 )$$

where [ ] denotes the indicator function. This equation counts how many times each nucleotide mapped to site s, i, using probabilistic counts expressed in q expectations under the possible patch alignments described by τ are again computed efficiently using dynamic programming, or, they can be simplified by using the most likely alignment.

EM algorithms employed by the optimization component 406 can iterate evaluating equations (2-5). The iterative nature of the algorithm allows a refinement in one set of parameters to aid in refining other parameters. For example, iterating the two equations in (4) can lead to estimates of strain frequency and variability in read coverage that are compatible with each other. The first equation can consider that some regions of the genome are under represented when assigning a frequency to strains based on the read counts; and the second equation discounts the effect of strain frequency on read counts to compute the read content dependent (approximated as genome position dependent) variability in coverage. On the other hand, the estimate of the epitome (e.g., the catalog of strains) and the strain frequency estimates are coupled through the posterior distribution q. Hence, a change in either one of these model parameters can affect the posterior distribution (2) which assigns reads to different strains, and this in turn affects these same model parameters in the next iteration.

A boost to performance of the algorithm utilized by the optimization component 406 can be achieved by its hierarchical application. The epitome e can be initialized by an epitome e that includes a smaller number learned in a previous run of the same algorithm (e.g., by repeating each of the original S strains K times and then adding small perturbations to form an initial epitome with SK strains). If the first number of strains S was insufficient, this new initial catalog of strains comprises rather uncertain sites wherever the population is polymorphic, but the alignments of variables l from the previous run for all patches are likely to stay the same, so that part of each distribution q(s, l) is transferred from the previous run, and does not change much, thus making it possible to avoid searching over this variable, thereby reducing complexity. According to an example where HIV population sequencing is conducted, the algorithm can be executed first with S=1, which can reduce to consensus strain assembly in noisy conditions, and then increase the catalog e to the desired size. For a further speed up, a known consensus sequence (or a profile) can be used to initialize all strains in the epitome.

Computational complexity (e.g., due to a potentially large number of reads) and local maxima problems (e.g., caused by weakness of concentration cues) can also be addressed by the reconstruction component 104 (and/or the optimization component 406). For instance, reads can be clustered using agglomerative clustering and the initial q distributions can be estimated by mapping the cluster representations rather than all reads.

The l mapping can be considered reliable and fixed thereafter as the described initialization makes all strains similar enough to the true solution for the purposes of l mapping (but not for inferring strain index s). In the first few iterations after that, clusters can be mapped to different strains, but the epitome distributions need not be considered in this mapping; rather, an assumption can be made that the final set of parameters will map clusters so that all strains in the epitome are used. Each cluster mapping can be iterated with updates of concentrations of p(s) (e.g., determined by the frequency analysis component 404). This results in loosely assigning read clusters with similar frequencies to the same strain. After 2-3 such iterations, epitome distributions can be inferred based on the resulting q distribution, and then the full EM algorithm, over all patches, is continued. This can be effectuated as the agglomerative clusters may not be sufficient to infer precisely the content of all sites until individual reads are considered. It should be noted that due to the high number and overlap of reads, it is in principle possible to have a substantially lower reconstruction error than the measurement error (1%).

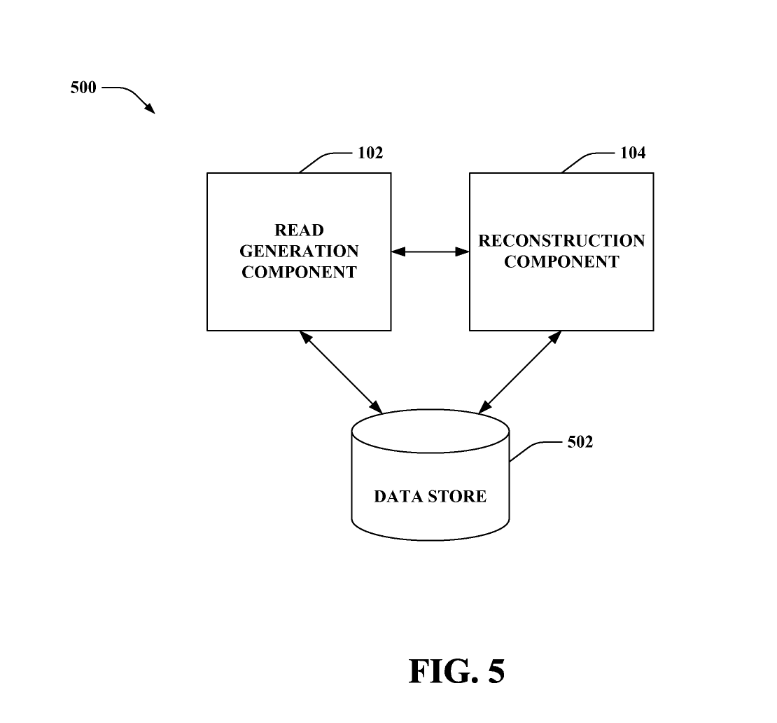

Now turning to FIG. 5, illustrated is a system 500 that sequences multiple different strains from a mixed sample. The system 500 includes the read generation component 102 that analyzes the sample to yield short reads. Further, the system 500 includes the reconstruction component 104 that evaluates and assembles the short reads to sequence variants included in the sample and/or determine concentrations of the variants in the sample. Moreover, the system 500 includes a data store 502 that can retain short reads obtained by the read generation component 102, strain estimate data generated by the reconstruction component 104, and the like. Moreover, the read generation component 102 and/or the reconstruction component 104 can retrieve and utilize data retained in the data store 502.

The data store 502 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 502 of the subject systems and methods is intended to comprise, without being limited to, these and any other suitable types of memory. In addition, it is to be appreciated that the data store 502 can be a server, a database, a hard drive, and the like.

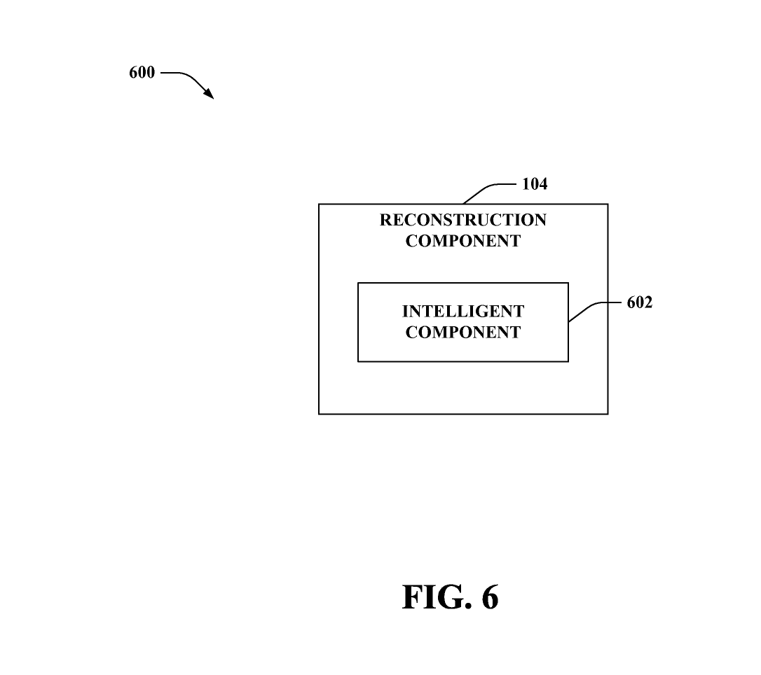

Turning to FIG. 6, illustrated is a system 600 that yields inferences in connection with sequencing multiple strain variants from a mixed sample. The system 600 can include the reconstruction component 104 that can be substantially similar to the aforementioned description. The reconstruction component 104 can further include an intelligent component 602. The intelligent component 602 can be utilized by the reconstruction component 104 to reason about whether short reads are taken from a common variant and/or disparate variants included the sample. Further, the intelligent component 602 can infer how to combine information associated with a plurality of short reads. Moreover, the intelligent component 602 can infer relative concentrations of variants included in the sample, locations from which the short reads were obtained, whether short reads include noise, and so forth.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

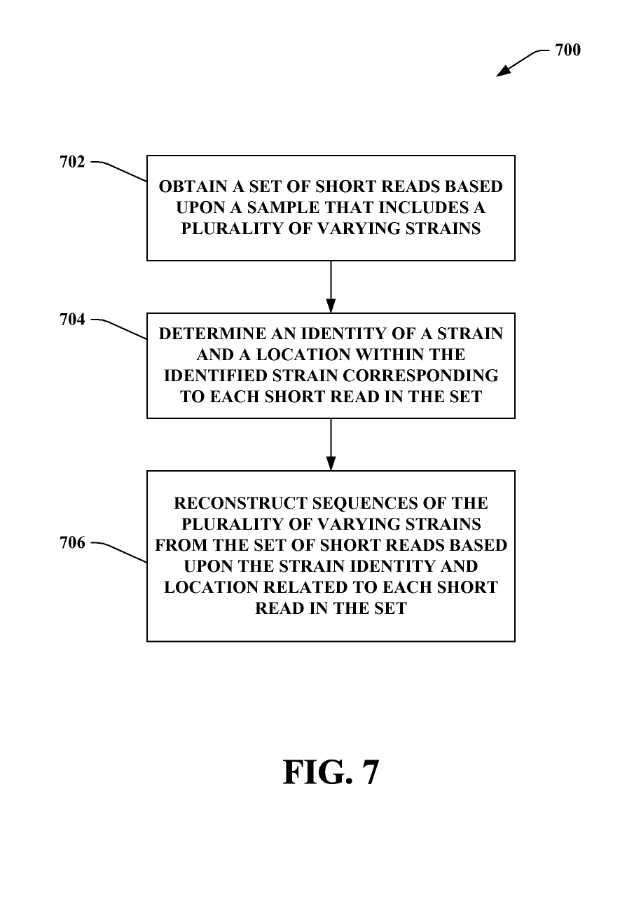

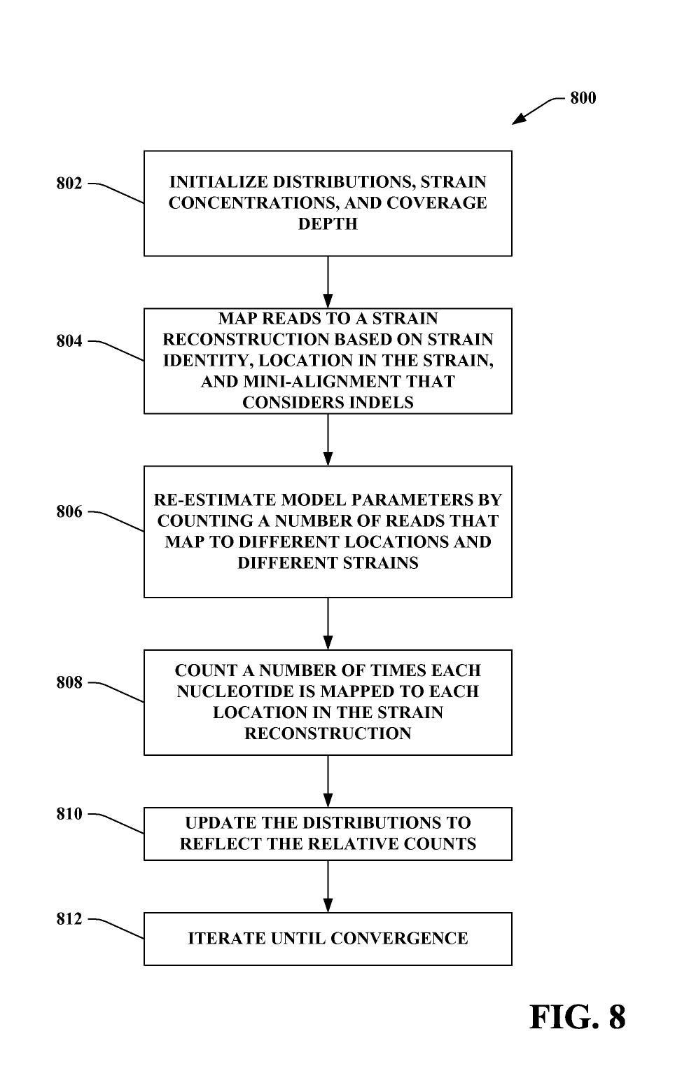

FIGS. 7-8 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events.

Turning to FIG. 7, illustrated is a methodology 700 that facilitates sequencing multiple variants included in a mixed sample. At 702, a set of short reads based upon a sample that includes a plurality of varying strains can be obtained. The sample can include variants from one species and/or multiple species. The set of short reads can comprise any number of short reads and the short reads can be from any of the plurality of varying strains. Moreover, the short reads can have similar and/or different lengths (e.g., lengths can be around 50 nucleotides, 100 nucleotides, 200 nucleotides, 500 nucleotides, . . . ). Further, each short read can have any starting position (e.g., starting site) within the sequence. The short reads can also be heavily overlapping such that each site in the sequence can be included in a large number of the short reads. At 704, an identity of a strain and a location within the identified strain can be determined corresponding to each short read in the set. At 706, sequences of the plurality of varying strains can be reconstructed from the set of short reads based upon the strain identity and location related to each short read in the set. According to another example, a mini alignment between each short read and a segment describing the appropriate strain starting at a given location can be considered for reconstruction. Further, various cues such as overlap of the short reads and frequency of each strain variant can be leveraged for reconstruction. Moreover, concentrations of each of the plurality of varying strains included in the sample can be yielded.

Now referring to FIG. 8, illustrated is a methodology 800 that facilitates reconstructing strains based upon probabilistic inferences. At 802, distributions (e.g., eᵢ^{s}), strain concentrations (e.g., p(s)), and coverage depth (e.g., p(l) can be initialized. At 804, reads can be mapped to a strain reconstruction based on strain identity, location in the strain, and mini-alignment that considers indels. For example, the strain identity, location, and mini-alignment associated with each read can be determined. At 806, model parameters can be re-estimated by counting a number of reads that map to different locations and different strains. At 808, a number of times each nucleotide is mapped to each location in the strain reconstruction can be counted. At 810, the distributions can be updated to reflect the relative counts (e.g., number of reads that map to different locations and different strains, number of times each nucleotide is mapped to each location, . . . ). At 812, the aforementioned can be iterated until convergence.

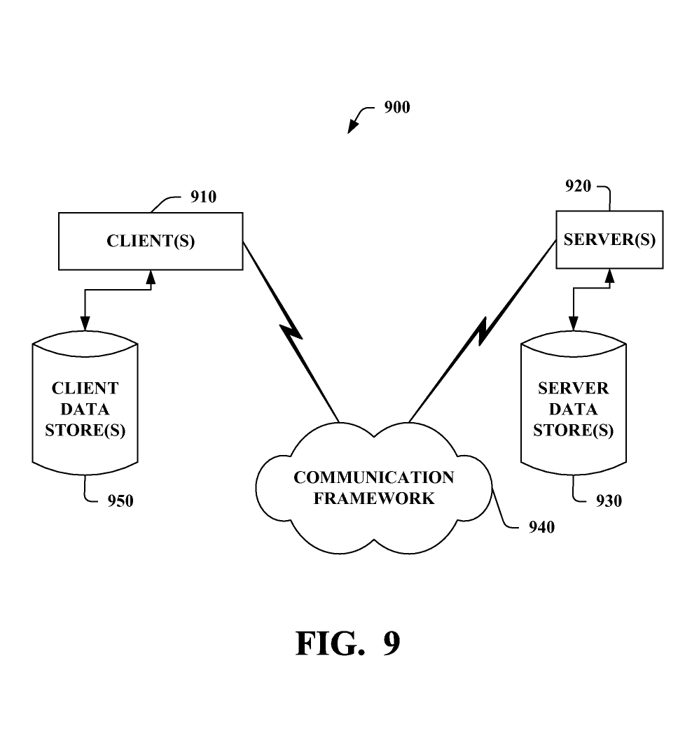

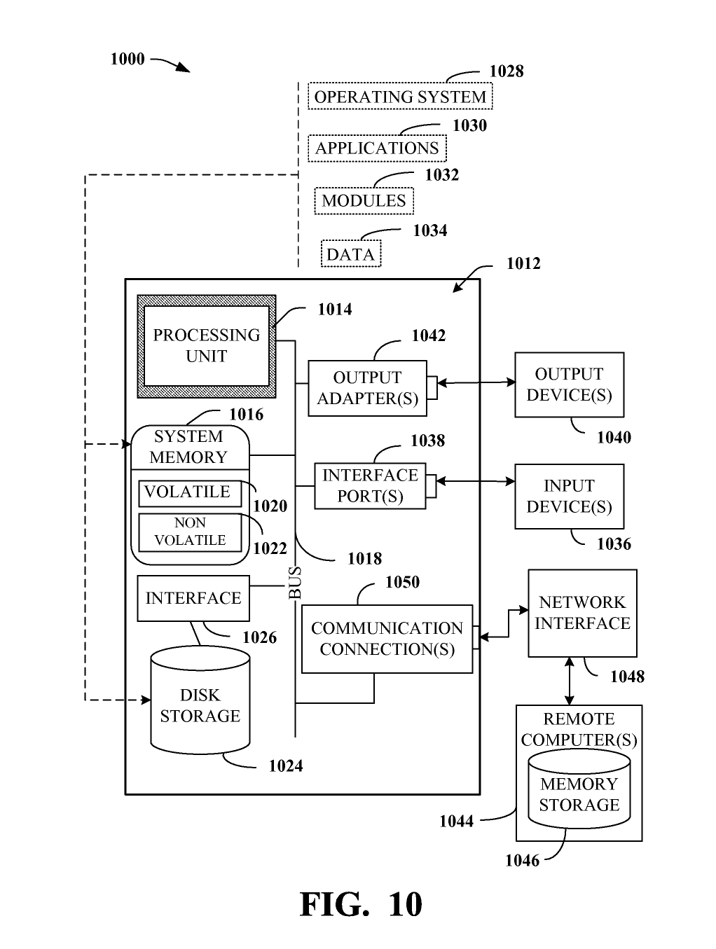

In order to provide additional context for implementing various aspects of the claimed subject matter, FIGS. 9-10 and the following discussion is intended to provide a brief, general description of a suitable computing environment in which the various aspects of the subject innovation may be implemented. For instance, FIGS. 9-10 set forth a suitable computing environment that can be employed in connection with sequencing multiple different strains from a mixed sample. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that enables generating population sequences based on short reads, comprising:
a read generation component that obtains short reads from a sample that includes a plurality of strain variants; and
a reconstruction component that combines the short reads to generate sequenced genomes associated with the plurality of strain variants in the sample and relative concentrations of the strain variants in the sample.

2. The system of claim 1, the plurality of strain variants includes at least one of variants from one species or variants from multiple species.

3. The system of claim 1, the read generation component obtains short reads from a mixture of samples.

4. The system of claim 1, the reconstruction component performs multi-strain assembly based upon likelihood optimization that leverages at least one cue evident from analysis of the short reads.

5. The system of claim 4, the at least one cue being one or more of different strain concentrations that lead to more frequently seen strains being responsible for more frequent reads or quilting of overlapping reads to infer mutation linkage over stretches of DNA.

6. The system of claim 1, the reconstruction component further comprising a strain identification component that determines an identity of a particular strain variant from the plurality of strain variants from which each obtained short read is generated.

7. The system of claim 1, the reconstruction component further comprising a location determination component that recognizes a corresponding position of each obtained short read within a sequence of a particular strain variant.

8. The system of claim 1, the reconstruction component further comprising an overlap component that links site variants from a subset of the obtained short reads based upon overlapping portions of the subset of the obtained short reads.

9. The system of claim 1, the reconstruction component further comprising a frequency analysis component that links site variants based upon respective frequencies exhibited in the obtained short reads.

10. The system of claim 1, the reconstruction component further evaluates a mini-alignment transformation that describes a finite set of possible minor insertions and deletions resultant from at least one of homopolymer issues in sequencing or insertions and deletions among strains.

11. The system of claim 1, the reconstruction component further comprising an optimization component that employs an expectation-maximization (EM) algorithm that optimizes a likelihood of obtaining the short read.

12. The system of claim 11, the optimization component estimates model parameters based on numbers of the obtained short reads that map to different locations l and different strains s, the parameters include at least one of relative concentrations of strains, variable depth of coverage for different locations in a genome, or an uncertainty over the nucleotide x present at a given site i in a strain s.

13. A method that facilitates sequencing multiple variants included in a mixed sample, comprising:
obtaining a set of short reads based upon a sample that includes a plurality of varying strains;
determining an identity of a strain and a location within the identified strain corresponding to each short read in the set; and
reconstructing sequences of the plurality of varying strains from the set of short reads based upon the strain identity and location related to each short read in the set.

14. The method of claim 13, reconstructing the sequences of the plurality of varying strains based upon mini alignments between each short read and a segment describing an appropriate strain starting at a given location.

15. The method of claim 13, reconstructing the sequences of the plurality of varying strains as a function of overlap of the short reads in the set determined based upon the strain identity and location related to each short read.

16. The method of claim 13, reconstructing the sequences of the plurality of varying strains as a function of frequencies of each of the plurality of varying strains.

17. The method of claim 13, further comprising determining concentrations of each of the plurality of varying strains included in the sample.

18. The method of claim 13, reconstructing the sequences of the plurality of varying strains based upon probabilistic inferences.

19. The method of claim 18, further comprising:
initializing distributions, strain concentrations, and coverage depth;
mapping short reads to a strain reconstruction based on the strain identity, the location within the identified strain, and mini alignment that considers indels;
re-estimating model parameters by counting a number of short reads that map to different locations and different strains;
counting a number of times each nucleotide is mapped to each location in the strain reconstruction;
updating the distributions to reflect relative counts; and
iterating until convergence.

20. A system that enables sequencing a plurality of variants included in a mixed sample, comprising:
means for determining respective strain identities corresponding to a plurality of short reads;
means for recognizing respective locations within the identified strains covered by each of the plurality of short read; and
means for assembling the plurality of short reads to reconstruct sequences of a plurality of strain variants based upon the respective strain identities and respective locations.
